(19) United States
(12) Patent Application Publication
(10) Pub. No.: US 2004/0158477 A1
(43) Pub. Date: Aug. 12, 2004

(54) Modified restaurant retail concept; "here and now networking" restaurant model

(76) Inventor: Olga Kostrova, Toronto (CA)

Correspondence Address: Olga Kostrova, 77 Quebec Ave., 1531, Toronto, ON, M6P 2T4, CA

(21) Appl. No.: 10/361,964

(22) Filed: Feb. 12, 2003

(51) Int. Cl. G06F 17/60

(52) U.S. Cl. 705/1

(57) ABSTRACT

The invention is a method of creating revenue by introducing a new type of restaurant that will operate by following specific rules. These rules encourage customers to continually visit any location from the restaurant chain in order to satisfy both their drinking/dining needs as well as social/dating desires. Every restaurant location has a similar guest registration system and seating procedure that obliges guests to sit with selected acquaintances and discuss topics of interest posted in the moment of registration. Another feature of the invention utilises a meeting desk designed for a guest to set a date to meet an acquaintance in a selected restaurant.

### FIELD OF THE INVENTION

The present invention creates a new type of service that is based on a specific service mix. It is a modified restaurant retail concept with a focus on satisfying peoples' needs in networking, socialising, and psychological encouragement. It is pioneering the concept of the “here and now networking” restaurant model.

### BACKGROUND OF THE INVENTION

Nowadays in the competitive food and beverage industry, restaurants differentiate from each other mostly by product assortment (menu) only. This new concept will have a strong competitive edge since it offers a complete package to customers. With this new type of restaurant, customers will satisfy not only their drinking/dining needs but also their needs in networking, socialising, and psychological encouragement.

Up till now, restaurants/cafes were places where only those outgoing individuals who can take initiative to introduce themselves to strangers would socialise. With this new concept, the restaurant's method of operation will dictate the rules that help any type of personality to find someone to socialise with at EVERY restaurant visit.

By visiting the restaurant, both men and women will meet each other without paying additional fees for dating services. Also, businesspeople can be acquainted with potential clients, vendors or partners without paying additional brokerage fees. As well, those in psychological turmoil, can find a pair of sympathetic ears to encourage them without asking any additional fees for psychological therapy.

### SUMMARY OF THE INVENTION

The applicant has invented a unique restaurant model which creates a new type of service based on a specific service mix. It is a modified restaurant retail concept with a focus on satisfying peoples' needs in networking, socialising, and psychological encouragement. One feature of the present invention is to provide a specific method of registration and seating for guests utilizing restaurant employees to introduce guests to each other based on table selection.

### DETAILED DESCRIPTION

The invention is a new type of restaurant that puts a fresh spin on spending time for breakfast, launch, dinner, of just having coffee/tea break.

Space Structure:

The innovative restaurants will have 4 major functional spaces in every location:

Registration desk

Silent room

Chat room

Meeting desk

A) Registration desk. This section is a very friendly space where restaurant employees (restaurant guide) welcome guests; explain the difference and benefits of this new type of restaurant; as well as take guest registration. The registration process consists of filling out a guest profile that includes guest name, occupation (optional), number of table, and chosen topic for discussion. The registration can be done electronically by displaying information on special computer monitors.

B) Silent room. This section is a regular restaurant room that works in the same way as any existing restaurants. It serves clients with meals and drinks with or without assistance of waiters.

C) Chat room. This is the specific invented space in the restaurant. If guests chose this section, they have to follow specific rules (see below). After the registration process is completed, the restaurant guide will escort the guest to the chosen table and introduce the chosen person. The introduction will be done according to guest profiles. Otherwise the guest will be escorted to an empty table and await new restaurant visitors.

D) Meeting desk. This is a special desk or monitor that can be used by a guest who wants to leave his/her notice for other visitors. This is used to inform selected acquaintances about the time of his/her next visit, and his specific interest. Please see example in Guest Experience below.

### Guest Experience

As stated above when visitors come to the Chat room area of the restaurant, they have to follow simple rules:

1. To decide if she/he is in a mood to chat or not.

2. If the visitor chooses to chat she/he has to review signatures (profiles) of other guests who are in at the moment and decide if she/he wants to join one of them or choose a separate table. New visitors can join his/her table but also new guest can choose another table.

3. To leave information about him/herself to be displayed for next visitors. It is additional fun to create unusual creative signature to pique the interest of next visitors.

All mentioned rules are designed to create a very open, friendly atmosphere that GUARANTEES every visitor will find a new person to chat with.

It will motivate clients to come in again and again.

An added feature of the restaurant is removing the fear of meeting new people. It doesn't matter how brave, outgoing or shy a guest is. The restaurant guide will provide the introduction service to each other by following the customer service instructions developed.

Guests will just enjoy their meal and take pleasure from new company.

A guest can check proceedings at the meeting desk and leave his own notice. For example: “Gary, musician. Will drop by Friday at 7 pm. I'm looking for a drummer for my band. If you know someone . . . Anyway, just join me for a chat”. He even can add photo to make stronger statement.

After a few visits, every guest will realize that he already knows a lot of people who come again and again. He knows their names, what they do, and what they reflect about. He will find himself in a very comfortable environment; a very open, friendly circle of friends. He will never need a reason to start conversation. The Customer service team will take care of everything.

I claim:

1. A method of creating revenue by introducing specific operating rules that encourage customers to continually visit any of the restaurants from the chain in order to satisfy their needs not only in drinking/dining, but also in meeting people for short- or long-term relationships.

2. The method of claim 1 above including the installation of hardware and software for guest registration (electronic signature) that will be collected and displayed internally in a local restaurant location. Information includes: name of the guest, occupation, table number, topics desired for here-and-now conversation.

3. The method of claim 2 above including the step of training employees by providing a corporate verbal scheme to politely implement steps 1 and 2 above: “As you may know we have two kinds of tables in two different rooms—a silent room and room for chat. If you chose the first one, you will enjoy your meal alone and nobody will disturb you. But if you chose the chat room you will fully enjoy the difference of our restaurant. I'd be happy to introduce you to any of the guests you would like to meet here. Please, take a brief look on the monitor. It shows the names of everybody who is here at the moment and the topics that would be in their interest for chat. Would you like me to introduce you to someone? Yes? What table did you chose? As you can see from the electronic signature of this person, her/his name is . . . , occupation is . . . and today she/he is in a mood to talk about . . . Would you like to leave your signature for any visitors?”

4. The method of claim 3 above including hiring employees who will be not only be servers but also will be restaurant guides. This employee will provide every upcoming guest with information about the restaurant rules, and will also introduce options available for guests—choice of silent room to enjoy solitude or choice of chat room to meet new acquaintances.

5. The method of claim 4 above including the step of assisting a customer in choosing to share a table with another customer in the chat room by pointing out all guest profile information displayed on the monitor.

6. The method of claim 5 above including the step of escorting a customer to the chosen guest whose profile has been selected.

7. The method of claim 6 above including the step of introducing these two or more people to each other in a polite and friendly manner by reviewing the information they included in their electronic signature.

8. The method of claim 7 above including the step of presenting the opportunity to a customer to leave their notice at the meeting desk after having a meal or drink.

9. The method of claim 8 above including the step of displaying welcoming words and a customer profile that includes his/her table posted for all guests to view.

10. The method of claim 9 above including the step of assisting guests in writing appropriate messages at the meeting desk and encourage a selected guest to return to the restaurant at the indicated time and day to meet the author of the message.
